(19) United States
(12) Patent Application Publication
(10) Pub. No.: US 2022/0303303 A1
(43) Pub. Date: Sep. 22, 2022

(54) Method and System for Security Monitoring on an OT System

(71) Applicant: Siemens Aktiengesellschaft, München (DE)

(72) Inventors: Wen Tang, Beijing (CN); Shuo Wan, Beijing (CN)

(73) Assignee: Siemens Aktiengesellschaft, München (DE)

(21) Appl. No.: 17/639,108

(22) PCT Filed: Aug. 29, 2019
(86) PCT No.: PCT/CN2019/103256

§ 371 Date: Feb. 28, 2022

(51) Int. Cl. H04L 9/40; H04L 41/22

(52) U.S. Cl. CPC H04L 63/1433; H04L 63/1425; H04L 41/22

(57) ABSTRACT

Various embodiments of the teachings herein include a method for security monitoring on an OT system. The method may include: determining a time range for calculation on data of the OT system; collecting from the OT system 10, data in the determined time range on a first aspect for security monitoring; calculating, based on data collected, an indicator on the first aspect; and visualizing the indicator on the aspect in a quantitative way.

### CROSS-REFERENCE TO RELATED APPLICATIONS

This application is a U.S. National Stage Application of International Application No. PCT/CN2019/103256 filed Aug. 29, 2019, which designates the United States of America. The contents of which is hereby incorporated by reference in their entirety.

### TECHNICAL FIELD

The present disclosure relates to techniques of security management. Various embodiment of the teachings herein include methods, systems, and/or computer-readable storage media for security monitoring on an OT system.

### BACKGROUND

According to Gartner, Operational Technology (OT) is hardware and software that detects or causes a change through direct monitoring and/or control of physical devices, processes, and events in the enterprise. OT includes the use of computers to monitor or alter the physical state of a system, particularly Industrial Control Systems (ICS) which are computer-based facilities, systems, and equipment used to remotely monitor and/or control critical process and physical functions. The term has become established to demonstrate the technological and functional differences between traditional IT systems and Industrial Control Systems environment, the so-called “IT in the non-carpeted areas”. Examples of operational technology include but not limited to: Supervisory Control And Data Acquisition (SCADA), Distributed Control Systems (DCS), Computer Numerical Control (CNC) systems, including computerized machine tools, scientific equipment (e.g. digital oscilloscopes), etc.

OT systems were traditionally closed systems designed for productivity, operability, and reliability, and with their reliance on proprietary networks and hardware. But with advancing of automation manufacture and process control technology, OT systems start to widely adopting IT technology, utilizing more intelligent OT equipment, and evolving into open systems with increased connectivity to other equipment/software as well as enhanced external connectivity; and more intelligent hackers and malware, make the traditional OT systems facing increasing security threats.

While OT system is facing more and more serious security threats, due to the OT area focuses on the production and operation of its core business, it often lacks of security professional, lacks of systematic network and information security management system, and more importantly, lacks of awareness of the security situation and security risks of its core OT system. This situation brings a huge security threat to key OT systems. At the same time, the persistent shortage of worldwide security professionals means that the shortage of security professionals as well as security capability will be very like existed in a long time. Therefore, it is necessary to introducing new technologies for providing an effective security management system for security situation of OT system, which can support the existing OT professionals, including factory directors, technical managers, IT/OT operation and maintenance personnel, to perceive the overall security situation of OT system and identify the security risks existing in their OT systems.

### SUMMARY

In some embodiments, a security monitoring system can collect data in a determined time range from an OT system, calculate indicator based on data collected on each of the at least one aspect, and visualize indicator on each of the at least one aspect in a quantitative way. With indicator on aspects for security monitoring to be visualized in a quantitative way, security situation of the monitored OT system can be aware in a precise and intuitive way.

For example, some embodiments include a method for security monitoring on an OT system comprising: determining a time range for calculation on data of the OT system for security monitoring; collecting, from the OT system, data in the determined time range for security monitoring on at least one aspect for security monitoring; calculating, indicator on each of the at least one aspect based on data collected; and visualizing, indicator on each of the at least one aspect in a quantitative way.

As another example, some embodiments include a security monitoring system for security monitoring on an OT system comprising: a processing module, configured to determine a time range for calculation on data of the OT system for security monitoring; a data collecting module, configured to collect data from the OT system in the determined time range for security monitoring on at least one aspect for security monitoring; a calculator, configured to calculate based on data collected indicator on each of the at least one aspect; and a visualization module, configured to visualize indicator on each of the at least one aspect in a quantitative way.

As another example, some embodiments include a security monitoring system for security monitoring on an OT system comprising: at least one memory configured to store instructions; at least one processor coupled to the at least one memory, and upon execution of the executable instructions, configured to execute following steps: determining a time range for calculation on data of the OT system for security monitoring; collecting from the OT system data in the determined time range for security monitoring on at least one aspect for security monitoring; calculating based on data collected indicator on each of the at least one aspect; and visualizing indicator on each of the at least one aspect in a quantitative way.

As another example, some embodiments include a computer-readable medium storing executable instructions, which upon execution by a processor, enables the processor to execute following steps: determining a time range for calculation on data of the OT system for security monitoring; collecting from the OT system data in the determined time range for security monitoring on at least one aspect for security monitoring; calculating based on data collected indicator on each of the at least one aspect; and visualizing indicator on each of the at least one aspect in a quantitative way.

### BRIEF DESCRIPTION OF THE DRAWINGS

The above-mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 depicts an exemplary OT system incorporating teachings of the present disclosure;

FIG. 2 depicts an exemplary embodiment of a security monitoring system incorporating teachings of the present disclosure;

FIG. 3 depicts a flow chart of a method for security monitoring incorporating teachings of the present disclosure;

FIG. 4 depicts a radar diagram incorporating teachings of the present disclosure; and

FIG. 5 and FIG. 6 depicts block diagrams displaying exemplary embodiments of a security monitoring system incorporating teachings of the present disclosure.

### DETAILED DESCRIPTION

In the present disclosure, with indicator on aspects for security monitoring to be visualized in a quantitative way, security situation of the monitored OT system can be aware in a precise and intuitive way. In some embodiments, the aspects for security monitoring comprise any or any combination of following aspects:
asset change, configured to indicate proportion of changed assets to total assets;
vulnerability, configured to indicate proportion of vulnerable assets to total assets;
network fluctuation, configured to indicate the amount of time slots in which there are at least one sub-network of the OT system has anomaly in its network traffic;
abnormal application, configured to indicate proportion of abnormal applications to total applications installed on hosts in the OT system;
account change, configured to indicate proportion of changed accounts to total accounts on hosts in the OT system;
maintenance activity, configured to indicate proportion of maintenance activities to historical maximum.

Research and analysis indicates that determinacy, periodicity, and stability of an OT system are its key characteristics, which are due to programmed, production-related operation, and mainly machine-to-machine communication, above 6 key aspects of OT system are selected which are critical for security of an OT system. If there are more changes (dynamic), non-deterministic happens in these aspects, it indicates the OT system has bigger attacking surface and therefore is exposed to more security risks. So with indicators on the above aspects to be calculated precisely, the major risks can be measured and visualized in a precise way, which makes it easier for engineers and users to be aware of security situation of the OT system.

In some embodiments, the security monitoring system can visualize indicator on each of the at least one aspect for the OT system (10) in comparison with indicator for at least one other OT system. With this solution, indicators can be compared between OT systems for identifying the OT system which faces higher risks.

In some embodiments, the security monitoring system can calculate an overall indicator from the indicators on the desired aspects of the OT system. With this solution, the overall indicator can provide a scalar (or a vector of scalars) measurement of the overall security situation of the OT system, with which a security threshold can be set, and alarms can be triggered by comparing the overall indicator with the security threshold.

Hereinafter, above-mentioned and other features of the present technique are described in detail. Various embodiments are described with reference to the drawings, where like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the scope of the disclosure. It may be evident that such embodiments may be practiced without these specific details.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements.

Based on many research and tests, following characteristics and methodology are found, which will be first introduced for better understanding of the present disclosure. According to research by inventor, different from IT systems, OT systems are mainly designed to support operation and production of specific industry. Behaviors of devices or assets in an OT system are mainly programmed (in advance) production-related operations. Therefore, communication in an OT system and between OT systems is also mainly machine-to-machine communication. Correspondingly, the communication and behavior in OT systems show obvious deterministic, periodicity and stability. When an OT system demonstrates strong non-deterministic and dynamic in system operation and maintenance, it usually indicates that OT system is exposed more to security risks. In the present disclosure, more specifically it can be summarized in the following six different aspects:

1) More (often) the assets changes in OT system, greater the risks

When assets in an OT system change frequently, e.g., go online or offline, change IP address, update control program, etc., or a lot of new assets appeared, it usually indicates that the OT system is under construction, commissioning, upgrading, or introducing new production processes, i.e., the OT system is in an unstable stage, which indicates that an OT system is vulnerable due to non-deterministic and dynamic changes, and generating more attacking surfaces for introducing of malware and attacks and other security risks.

2) More vulnerabilities (especially those that can be exploited automatically and remotely) existed in OT system, greater the risks

Like IT systems, security vulnerabilities in devices, OS and applications are major weakness for OT systems. But what is quite different is that OT systems in most cases can't patch as frequently as IT systems due to strong requirements on none stop operation and production, devices normally provided by third parties, thorough compatible testing needed, etc. Therefore, there are more security vulnerabilities in OT systems that have not been patched. Obviously, the more security vulnerabilities exist, the more security risks OT system faces.

On the other hand, since OT systems are usually isolated with very limited access, so the risk of vulnerabilities which can only be exploited locally is usually low. Therefore, in some embodiments of the present disclosure we are more concerned about security vulnerabilities that can be exploited remotely and automatically, such as CVE 2017-0143˜0148 (also known as MS17-010), or BlueKeep RDP vulnerability (CVE 2019-0708), etc.

3) More network fluctuations in an OT system, the greater the risks

In the process of supporting OT operations and productions, due to the deterministic and periodicity of machine-to-machine communication, the network traffic of an OT system usually is (supposed to be) very stable. Therefore, while large fluctuation happens in OT network, the reason could be network fault (network storm) caused by misconfiguration, network access or behavior violating security policy, Denial of Service(DoS) attack, communication generated by malware, data exfiltration, and so on. In all cases, the greater the fluctuation of the network traffic, the greater risk the OT system will face.

4) More abnormal applications (not in legitimate baseline) installed on OT hosts, greater the risks

In an OT system, even though hosts, such as HMI, operator station, engineer station and servers, are also based on Windows PC, they are still dedicated systems for specific OT operation and production purposes, and applications and software installed on them should be clearly defined. Therefore, these applications which required by OT operation and production can be put into a baseline (whitelist). If there are applications not listed in the baseline on an OT host, it indicates that the host is likely to be used for purpose other than it is designed for, and therefore potential risks can be introduced, or malware infection and persistence has already happened. In this case, an OT system will be certainly exposed to greater security risks.

5) More changes (anomalies) happen on accounts in OT system, greater the risk

In an OT system, accounts for OT stations and systems are supposed to be used for operation, production and maintenance only. And the quantity, privilege and behavior of these accounts should be well defined and demonstrate certain deterministic. Therefore, new (undefined) accounts' appearance, new privilege's assignment, or unexpected behaviors' (login, access, etc.) appearance in an OT system indicates that the OT system is in riskier status if not already being compromised.

6) More usage of mobile storage device (such as a USB device) and (on-site or remote) maintenance activities, the greater the risk

In recent years, various security incidents in OT area show that USB usage, on-site and remote and maintenance becomes the major attack surfaces to OT system. The malware, e.g., Stuxnet, often penetrate into an isolated OT system through uncontrolled USB storage device, on-site maintenance lacks of security control, or a remote maintenance from third-party vendor. Therefore, the more USB usage, on-site as well as remote maintenance happens in an OT system, the system is exposed to greater security risk.

7) Other aspects which can invoke risks to an OT system

Above mentioned aspects or dimensions cover major risks faced by an OT system in operation, production and maintenance.

Based on the above research on major aspects or dimensions of characteristics of OT systems, the present disclosure describes security monitoring method and system on an OT system. With quantification of security risks, the risks an OT system faces can be estimated precisely. In some embodiments, with visualization of quantification of security risks, security situation and operational risks of an OT system can be demonstrated intuitively. Furthermore, with all above major aspects being visualized together in a comparative way, an overall security situation of an OT system can be clearly presented.

Now the present technique will be described hereinafter in details by referring to FIGS. 1 to 4. By way of introduction, FIG. 1 depicts an OT system 10 may include, but is not limited to, the following assets:

1) At Least One Industrial Controller 1011

Industrial controller 1011 can be programmable logic controller (PLC), DCS controller, RTU, etc. At least one industrial controller 1011 can connect a distributed I/O device 1012 or self-integrated distributed I/O interface to control the input and output of data. The industrial controller 1011 can also connect the field device 40 to control the operation of the field device 40. Most industrial controllers 1011 are dedicated embedded devices, based on embedded operating systems (such as: VxWorks, embedded Linux, EOS, ucLinux, and various private operating systems). Industrial controller 1011 is used to implement reliable and real-time industrial control. It usually lacks security features such as access control (such as identification, authentication, authorization, etc.). One control unit 100 may include at least one industrial controller 1011.

2) At Least One Distributed Input/Output (I/O) Device 1012

3) At Least One Industrial Host

Industrial hosts may include various workstations or servers based on personal computers (PC). For example, engineer station 1013a, operator station 1013b, server 1013c and human machine interface (HMI) 1013d, etc. In OT system 10, industrial host can monitor and control industrial controller 1011 through industrial Ethernet 1014. For example, control industrial controller 1011 can read data from 40 field devices (e.g. from sensors), save data to historical database, according to operator's instructions or according to preset. Control program or logic, send control commands to industrial controller 1011, etc. Among them, engineer station 1013a can also configure industrial controller 1011.

4) Industrial Control Network 1014

Industrial control network 1014 may include at least one network device for connecting various industrial controllers 1011 and industrial hosts. At present, more and more industrial control network 1014 is implemented based on industrial Ethernet. Communication within industrial control network 1014 can be based on transmission control protocol (TCP), user data gram protocol (UDP), Internet Protocol (IP), and Ethernet (Ethernet), among which network devices may include but are not limited to: router, switch, etc. Industrial control network 1014 can also connect to other networks, such as factory network, office network, etc.

To be mentioned that, OT system 10 depicted in FIG. 1 is just an example. Structures and devices may vary among different OT systems.

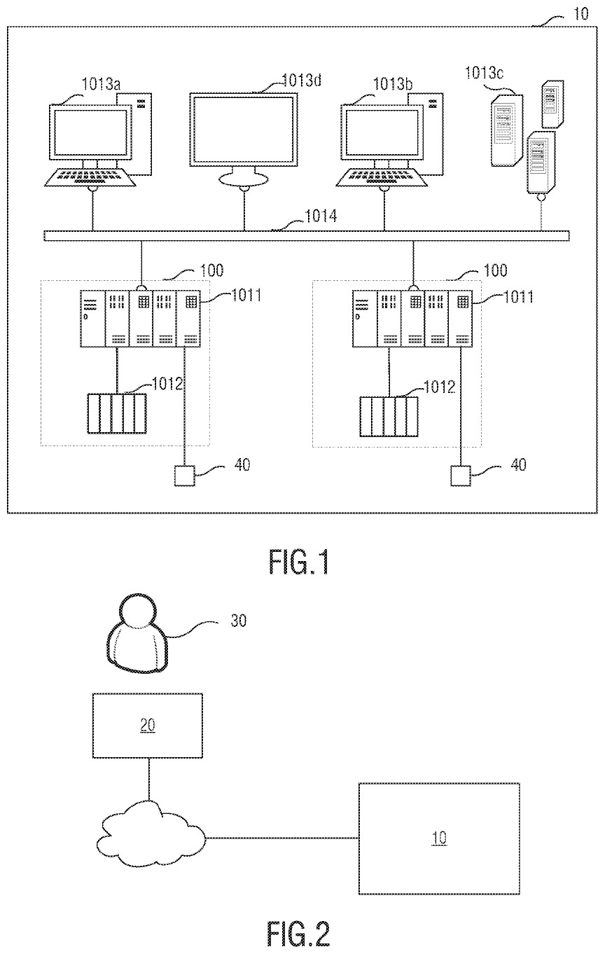

FIG. 2 depicts a security monitoring system 20 which can conduct security monitoring on the OT system 10. The security monitoring system 20 can be connected to the OT system 10 via internet, or a private network. Or the security monitoring system 20 can be deployed inside the OT system 10. The security monitoring system 20 can collect information mentioned above, and based on the collected information, conduct security monitoring on the OT system 10. Information can be collected via security components deployed in the OT system 10 which conduct network traffic monitoring, security log collection, for collecting the relevant data of the OT system 10. Assuming the total number (denoted as n) of assets in the OT system 10 can be obtained from the security monitoring. A user 30, such as a maintenance engineer for the OT system 10 can interact with the security monitoring system 20, inputting commands, view monitoring results output by the security monitoring system 20, etc.

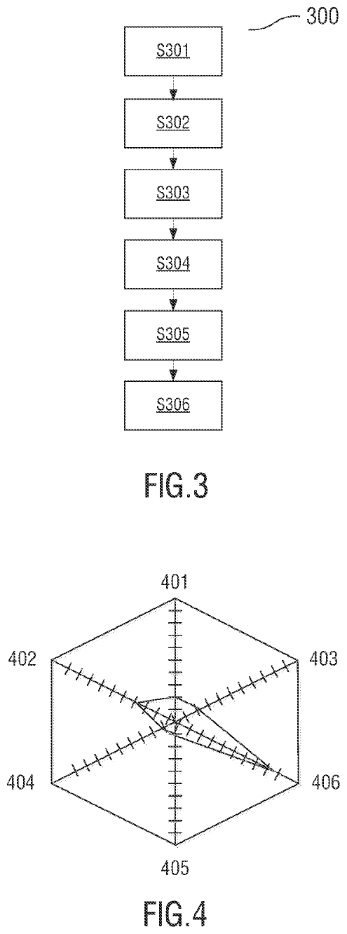

FIG. 3 depicts a flow chart for security monitoring executed by the security monitoring system 20. The method 300 can include following steps:

S301: determining, at the security monitoring system 20, a time range of calculation on data of the OT system 10 for security monitoring. For example, the security monitoring system 20 can receive a user 30's input of a time range, such as 24 hours (but not limited to) to the current time by default. And user 30 can change it to one week, one month, etc. Or, the security monitoring system 20 can take a predefined time range for calculation.

S302: receiving, at the security monitoring system 20, user 30's input of desired aspects of calculation. The desired aspects can be defined by user 30's input which can include but not limited to any of the above mentioned 6 major aspects. To be mentioned that, this step S302 is optional, the security monitoring system 20 can take all predefined aspects for statistics.

S303: collecting, from the OT system 10, data in the time range specified in step S301 for security monitoring on the desired aspects input by the user 30. For example, when an event (a mobile storage device's being plugged in an engineer station) happens in an OT system, time stamp of the event will be recorded together with data describing the event. So data describing an event will be labelled with a time stamp. In this step, when collecting data in the time range, data with a time stamp with fall in the time range will be collected.

S304: calculating, based on data collected, indicator(s) on each desired aspect.

1) Asset Changes

Optionally, we can calculate y₁, which is the amount of OT assets changing within the time range specified in the step S301. Here asset changes include but not limited to: asset goes online, asset goes offline, asset attribute changes, etc. Then the indicator of asset change, x₁ can be calculated as:

x₁=ƒ₁(y₁,n)

Here ƒ₁ denotes a function which mapping y₁ and n to corresponding indicator x₁ on asset change.

In an embodiment, while not limited, function ƒ₁ is as following,

$${f}_{1} ( {y}_{1} , n ) = \{ \begin{matrix}⌈ \frac{{y}_{1}}{n} ⌉ * s , if {y}_{1} < n * 10 \% \\ \frac{{y}_{1}}{n} * s , if {y}_{1} \geq n * 10 \%\end{matrix}$$

Here s is the scale 10 which maps y₁ into value range[1,10]. Therefore, the indicator on asset change is the proportion of changed assets to total assets. For avoiding small amount of asset changes in the OT system 10 (e.g., less than 10% of total assets) has been ignored, ceil function, [symbol] [symbol] has been introduced to make sure if there is any change happens, the indicator on assets change is at least 1.

2) Vulnerability

Optionally, we can calculate y₂ which is the amount of vulnerable assets (such as predefined highly critical assets with remote exploitable security vulnerabilities) within the time range specified in the step S301. Then the indicator of vulnerability, x₂ can be calculated as:

x₂=ƒ₂(y₂,n)

Here ƒ₂ denotes a function which maps y₂ and n to corresponding indicator x₂ on vulnerability.

In some embodiments, function h is as following,

$${f}_{2} ( {m}_{2} , n ) = \{ \begin{matrix}⌈ \frac{{y}_{2}}{n} ⌉ * s , & if {y}_{2} < n * 10 \% \\ \frac{{y}_{2}}{n} * s , & if {y}_{2} \geq n * 10 \%\end{matrix}$$

Here s is the scale 10 which maps x₂ into value range [1,10]. Therefore, the indicator on vulnerability is proportion of vulnerable assets to total assets. For avoiding small amount of vulnerable asset in the OT system 10 (e.g., less than 10% of total assets) has been ignored, ceil function, [symbol] [symbol] has been introduced to make sure if there is any vulnerable asset, the indicator on vulnerability is at least 1.

3) Network Fluctuation

Optionally, we can calculate y₃ which is the amount of anomaly of network traffic of the OT system 10 (such as newly appeared application flow, DNS beaconing, network scanning, etc.), and t is the time range specified in step S301. Then the indicator of network (traffic) dimension, x₃ can be calculated as:

x₃=ƒ₃(y₃,t)

Here ƒ₃ denotes a function which mapping y₃ and t to corresponding indicator x₃ on network dimension.

In some embodiments, t=time range (days)*24, i.e., utilizing the specified time range in hours as the time slots for calculation. Assume the OT system 10 consists of multiple sub-network (separated by routers). Then y₃ will be the amount of time slots in which at least one sub-network has anomaly in its network traffic, i.e., the network traffic is beyond its moving average plus 2 times of standard deviation.

$${f}_{3} ( {y}_{3} , t ) = \frac{{y}_{3}}{t} * s$$

Here s is the scale 10 which maps x₃ into value range [1,10]. Therefore, the indicator on network (load) dimension is the proportion of time slots with excessive network traffic to all time slots in the specified time range.

4) Abnormal Application

In some embodiments, we can calculate m, which is the amount of applications (all types of applications or predefined types of applications) installed on host computers in the OT system 10, calculate y₄ which is the amount of abnormal applications (e.g. software not listed in the baseline). Then the indicator of abnormal application, x₄ can be calculated as:

x₄=ƒ₄(y₄,m)

Here ƒ₄ denotes a function which mapping y₄ and m to corresponding indicator x₄ on abnormal application.

In some embodiments, function ƒ₄ is as following,

$${f}_{4} ( {y}_{4} , m ) = \{ \begin{matrix}⌈ \frac{{y}_{4}}{m} ⌉ * s , & if {y}_{4} < m * 10 \% \\ \frac{{y}_{4}}{m} * s , & if {y}_{4} \geq m * 10 \%\end{matrix}$$

Here s is the scale 10 which maps y₄ into value range [1,10]. Therefore, the indicator on abnormal application is the proportion of abnormal applications to total applications installed on hosts in the OT system 10. For avoiding small amount of abnormal applications in the OT system 10 (e.g., less than 10% of total applications) has been ignored, ceil function, [symbol] [symbol] has been introduced to make sure if there is any abnormal application, the indicator on application abnormal is at least 1.

5) Account Change

In some embodiments, we can calculate l, which is amount of accounts on host in the OT system 10, calculate y₅ which is the amount of changed accounts. Then the indicator of account change, x₅ can be calculated as:

x₅=ƒ₅(y₅,l)

Here ƒ₅ denotes a function which maps y₅ and l to corresponding indicator x₅ on account change.

In some embodiments, function ƒ₅ is as following,

$${f}_{5} ( {y}_{5} , l ) = \{ \begin{matrix}⌈ \frac{{y}_{5}}{l} ⌉ * s , & if {y}_{5} < l * 10 \% \\ \frac{{y}_{5}}{l} * s , & if {y}_{5} \geq l * 10 \%\end{matrix}$$

Here s is the scale 10 which maps y₅ into value range [1, 10]. Therefore, the indicator on account change is the proportion of changed accounts to total accounts on hosts in the OT system 10. For avoiding small amount of changed accounts in the OT system 10 (e.g., less than 10% of total accounts) has been ignored, ceil function, [symbol] [symbol] has been introduced to make sure if there is any changed accounts, the indicator on account change is at least 1.

6) Maintenance Activities

Optionally, we can calculate following values, wherein:

y_{6,1} is the amount of mobile storage device activities within the time range specified in the step S301, while max₁ is the maximum amount of mobile storage device activities (in the same long time range) in the history of the OT system 10;

y_{6,2} is the amount of onsite maintenance activities within the time range specified in the step S301, while max₂ is the maximum amount of onsite maintenance activities (in the same long time range) in the history of OT system 10;

y_{6,3} is the amount of remote maintenance activities within the time range specified in the step S301, while max₃ is the maximum amount of remote maintenance activities (in the same long time range) in the history of OT system 10.

Then the indicator of maintenance activities, x₆ can be calculated as:

x₆=ƒ₆(y_{6,1},y_{6,2},y_{6,3},max₁,max₂,max₃)

In some embodiments, function ƒ₆ is as following,

$${f}_{6} ( {y}_{6 , 1} , {y}_{6 , 2} , {y}_{6 , 3} , {max}_{1} , {max}_{2} , {max}_{3} ) = \{ \begin{matrix}⌈ \frac{\frac{{y}_{6 , 1}}{{max}_{1}} + \frac{{y}_{6 , 2}}{{max}_{2}} + \frac{{y}_{6 , 3}}{{max}_{3}}}{3} ⌉ * s , if {y}_{5} < l * 10 \% \\ \frac{\frac{{y}_{6 , 1}}{{max}_{1}} + \frac{{y}_{6 , 2}}{{max}_{2}} + \frac{{y}_{6 , 3}}{{max}_{3}}}{3} * s , if {y}_{5} \geq l * 10 \%\end{matrix}$$

Here s is the scale 10 which maps x₆ into value range [1, 10]. Therefore, the indicator on maintenance activities is average of the proportion of mobile storage device activities, on-site maintenance and remote maintenance to their historical maximum separately. For avoiding the small amount of maintenance activities in the OT system 10 (e.g., less than 10% of maximum activities) has been ignored, ceil function, [symbol] [symbol] has been introduced to make sure if there is any maintenance activities, the indicator on maintenance activities is at least 1.

S305: visualizing, at the security monitoring system 20, indicator on each of the at least one aspect in a quantitative way. In this step, first, view of indicator can be generated, for example, for each indicator, one view will be generated. If there are more than indicators, view for each indicator will be visualized respectively. Another example is that, for all indicators, a single view will be generated, the indicators will be showed in the single view, for convenience of the user to have fast understanding of security situation of the OT system 10. Optionally, the monitoring system 20 can visualize indicator on each of the at least one aspect for the OT system 10 in comparison with indicator for at least one other OT system.

Generating, at the security monitoring system 20, view of indicators on the desired aspects input by the user 30 in step S303 in a quantitative way, and visualize the view to the user 30. The view can be a radar diagram, a bar chart, a pie chart, etc. Here “in a quantitative way” can mean that the size of the visualized indicators depends on risk level the corresponding aspect for security monitoring.

FIG. 4 shows an example of the view. It is a radar diagram, in which indicators of the above 6 aspects asset change 401, vulnerability 402, network fluctuation 403, abnormal application 404, account change 405 and maintenance activity 406 are showed, which reflects cyber security situation of the OT system 10. Based on the visualization of security situation, user 30 can easily establish cyber security awareness on the monitored OT system 10, identify aspects which need to improve for reducing risk of the OT system 10.

Taking the radar diagram showed in FIG. 4 as an example, the OT system 10 is in pretty good situation on asset change 401, vulnerability 402, abnormal application 404, account change 405 and network fluctuation 403, but it has lot of activities on mobile storage device usage and local/remote maintenance. The radar diagram indicates that there is more risk on maintenance activity 406, and security problem will be more likely to be introduced via usage of mobile storage device and local/remote maintenance, and therefore deserve more attention for risk mitigation.

In some embodiments, the security monitoring system 20 can proceed with step S306 after step S305. In step S306, the security monitoring system 20 can calculate an overall indicator r from the indicators on the desired aspects of the OT system 10, taking all above mentioned 6 aspects as desired aspects, the overall indicator r can be denoted as:

r=ƒ(x₁,x₂,x₃,x₄,x₅,x₆)

Here ƒ denotes a function of the 6 indicators to corresponding overall security risk indicator r.

In some embodiments, function f is as following,

ƒ(x₁,x₂,x₃,x₄,x₅,x₆)=(x₁+2*x₂+x₃+2*x₄+3*x₅+3*x₆)/12

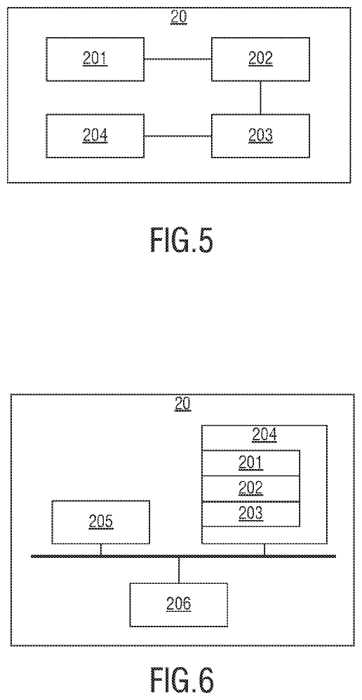

FIG. 5 depicts a block diagram displaying an exemplary embodiment of a security monitoring system 20 incorporating teachings of the present disclosure. Referring to FIG. 5, the security monitoring system 20 can include:
a processing module 201, configured to determine a time range for calculation on data of the OT system 10 for security monitoring;
a data collecting module 202, configured to collect from the OT system 10 data in the determined time range for security monitoring on at least one aspect for security monitoring;
a calculator 203, configured to calculate based on data collected indicator on each of the at least one aspect;
a visualization module 204, configured to visualize indicator on each of the at least one aspect in a quantitative way.

In some embodiments, the aspects for security monitoring comprise any or any combination of following aspects:
asset change 401, configured to indicate proportion of changed assets to total assets;
vulnerability 402, configured to indicate proportion of vulnerable assets to total assets;
network fluctuation 403, configured to indicate the amount of time slots in which there are at least one sub-network of the OT system 10 has anomaly in its network traffic;
abnormal application 404, configured to indicate proportion of abnormal applications to total applications installed on hosts in the OT system 10;
account change 405, configured to indicate proportion of changed accounts to total accounts on hosts in the OT system 10;
maintenance activity 406, configured to indicate proportion of maintenance activities to historical maximum.

In some embodiments, the visualization module 204 is further configured to visualize the indicators in a single view and in a comparative way, if there are more than 1 indicators.

In some embodiments, the calculator 203 is further configured to calculate an overall indicator from the indicators on the desired aspects of the OT system 10.

FIG. 6 depicts another block diagram displaying an exemplary embodiment of a security monitoring system 20 incorporating teachings of the present disclosure. Referring to FIG. 7, the security monitoring system 20 can include:
at least one memory 205, configured to store instructions; and
at least one processor 206, coupled to the at least one memory 205, and upon execution of the executable instructions, configured to execute the steps executed by the security monitoring system 20 according to method 300.

In some embodiments, the security monitoring system 20 may also include a communication module 207, configured to communication with the OT system 10. The at least one processor 206, the at least one memory 205 and the communication module 207 can be connected via a bus, or connected directly to each other. In some embodiments, the above mentioned modules 201204 can be software modules including instructions which are stored in the at least one memory 205, when executed by the at least one processor 206, execute the method 300.

In some embodiments, a computer-readable medium stores executable instructions, which upon execution by a computer, enables the computer to execute any of the methods described in this disclosure. In some embodiments, a computer program, executed by at least one processor, performs any of the methods presented in this disclosure.

The teachings of the present disclosure, include methods and/or systems wherein characteristics of determinacy, periodicity and stability of an OT system are analysed, which can be due to programmed, production-related operation and mainly machine-to-machine communication in an OT system. Based on the analysis, a visualized security situation awareness solution is provided, in which key aspects of OT system are selected, they are asset change, vulnerability, network fluctuation, abnormal application, account change and maintenance activity, which are critical for security of an OT system. If there are more changes (dynamic), non-deterministic happens in these aspects, it indicates that an OT system may have bigger attacking surfaces and therefore may be exposed to more security risks.

Algorithms calculating indicators on the 6 different aspects for security monitoring of an OT system are also provided, making sure of precise measurement of security situation. A view can integrate indicators of the key aspects together, and provide a simple, intuitive and visualized way for cyber security awareness of an OT system. Therefore, users such as an OT manager or an operator can easily percept the overall security risk that the OT system faces and identify the aspects which need to improve for reducing the risk of the OT system.

In some embodiments, the overall indicator from indicators on the key aspects of an OT system can be calculated based on the quantized indicators on the key aspects of an OT system.

While the present technique has been described in detail with reference to certain embodiments, it should be appreciated that the present technique is not limited to those precise embodiments. Rather, in view of the present disclosure which describes exemplary modes for practicing the teachings herein, many modifications and variations would present themselves, to those skilled in the art without departing from the scope and spirit of this disclosure. The scope of the teachings is, therefore, indicated by the following claims rather than by the foregoing description. All changes, modifications, and variations coming within the meaning and range of equivalency of the claims are to be considered within their scope.

### REFERENCE NUMBERS

10, an OT system
20, a security monitoring system
30, a user
100, control unit
1011, industrial controller
1012, I/O device
1013a, engineer station
1013b, operator station
1013c, server
1013d, HMI
1014, industrial control network
40, field device
401, asset change
402, vulnerability
403, network fluctuation
404, abnormal application
405, account change
406, maintenance activity
S301˜S306: steps
201, a processing module
202, a data collecting module
203, a calculator
204, a visualization module
205, at least one memory
206, at least one processor
207, communication module

What is claimed is:

1. A method for security monitoring on an OT system, the method comprising:
determining a time range for calculation on data of the OT system;
collecting from the OT system 10, data in the determined time range on a first aspect for security monitoring;
calculating, based on data collected, an indicator on the first aspect;
visualizing the indicator on the aspect in in a quantitative way.

2. The method according to claim 1, wherein the aspects for security monitoring comprise one or more aspects selected from the group consisting of:
an asset change value indicating a proportion of changed assets to total assets;
a vulnerability indicating a proportion of vulnerable assets to total assets;
a network fluctuation value indicating an amount of time slots in which there are at least one sub-network of the OT system has an anomaly in its network traffic;
an abnormal application value indicating a proportion of abnormal applications to total applications installed on hosts in the OT system;
an account change value indicating a proportion of changed accounts to total accounts on hosts in the OT system; and
a maintenance activity, value indicating a proportion of maintenance activities to historical maximum.

3. The method according to claim 1, wherein visualizing an indicator on the first aspect in a quantitative way comprises
visualizing the indicator on the first aspect for the OT system in comparison with indicator for at least one other OT system.

4. The method according to claim 1, further comprising
calculating an overall indicator from the indicators on the desired aspects of the OT system.

5. A security monitoring system for security monitoring on an OT system, the security monitoring system comprising:
a processing module configured to determine a time range for calculation on data of the OT system;
a data collecting module configured to collect from the OT system data in the determined time range on a first aspect for security monitoring;
a calculator configured to calculate based on data collected indicator on each of the first aspect;
a visualization module configured to visualize an indicator on the first aspect in a quantitative way.

6. The security monitoring system according to claim 5, wherein the first aspect comprises one or more aspects for security monitoring selected from the group consisting of:
an asset change value indicating a proportion of changed assets to total assets;
a vulnerability value indicating a proportion of vulnerable assets to total assets;
a network fluctuation value indicating an amount of time slots in which there are at least one sub-network of the OT system has an anomaly in its network traffic;
an abnormal application value indicating a proportion of abnormal applications to total applications installed on hosts in the OT system;
an account change value indicating a proportion of changed accounts to total accounts on hosts in the OT system; and
a maintenance activity value indicating a proportion of maintenance activities to historical maximum.

7. The security monitoring system according to claim 5, wherein the visualization module is further configured to
visualize an indicator on the first aspect for the OT system in comparison with an indicator for at least one other OT system.

8. The security monitoring system according to claim 5, wherein the calculator is further configured to
calculate an overall indicator from the indicators on the desired aspects of the OT system.

9. A security monitoring system for security monitoring on an OT system, the security monitoring comprising:
a memory configured to store instructions;
a processor coupled to the memory, and upon execution of the instructions, configured to:
determine a time range for calculation on data of the OT system;
collecting from the OT system data in the determined time range g on a first aspect for security monitoring;
calculating based on data collected an indicator on the first aspect;
visualizing the indicator on first aspect in a quantitative way.

10. The security monitoring system according to claim 9, wherein the aspects for security monitoring comprise one or more aspects selected from the group consisting of:
an asset change value indicating a proportion of changed assets to total assets;
a vulnerability value indicating a proportion of vulnerable assets to total assets;
a network fluctuation value indicating an amount of time slots in which there are at least one sub-network of the OT system has an anomaly in its network traffic;
an abnormal application value indictig a proportion of abnormal applications to total applications installed on hosts in the OT system;
an account change value indicating a proportion of changed accounts to total accounts on hosts in the OT system; and
a maintenance activity value indicating a proportion of maintenance activities to historical maximum.

11. The security monitoring system according to claim 9, wherein when visualizing the indicator on the first aspect in a quantitative way, the processor upon execution of the executable instructions,
visualizes the indicator on the first aspect for the OT system in comparison with an indicator for at least one other OT system.

12. The security monitoring system according to claim 9, wherein the processor, upon execution of the executable instructions,
calculates an overall indicator from the indicators on the desired aspects of the OT system.

13. A computer-readable medium, storing executable instructions, which upon execution by a processor, causes the processor to:
determine a time range for calculation on data of the OT system;
collect from the OT system data in the determined time range for a first aspect for security monitoring;
calculating based on data collected an indicator on the first aspect; and
visualizing an indicator on first aspect in a quantitative way.

14. The computer-readable medium according to claim 13, wherein the first aspect comprises one or more aspects selected from a group of aspects for security monitoring consisting of:
an asset change value indicating a proportion of changed assets to total assets;
a vulnerability value indicating a proportion of vulnerable assets to total assets;
a network fluctuation value indicating an amount of time slots in which there are at least one sub-network of the OT system has anomaly in its network traffic;
an abnormal application value indicating a proportion of abnormal applications to total applications installed on hosts in the OT system;
an account change value indicating a proportion of changed accounts to total accounts on hosts in the OT system; and
a maintenance activity value indicating a proportion of maintenance activities to historical maximum.

15. The computer-readable medium according to claim 13, wherein when visualizing the indicator on the first aspect in a quantitative way, the executable instructions, which upon execution by a processor, further cause the processor to
visualize the indicators in a single view and in a comparative way, if there are more than 1 indicators.

16. The computer-readable medium according to claim 13, wherein the executable instructions, which upon execution by a processor, further cause the processor to calculate an overall indicator from the indicators on the desired aspects of the OT system.
